(19) United States
(12) Patent Application Publication
(10) Pub. No.: US 2015/0267788 A1
(43) Pub. Date: Sep. 24, 2015

(54) TORQUE MIXING DEVICE AND METHOD FOR DRIVING THE SAME

(71) Applicant: KABUSHIKI KAISHA TOSHIBA, Tokyo (JP)

(72) Inventor: YOSHIYUKI ISHIHARA, Kawasaki (JP)

(21) Appl. No.: 14/610,402

(22) Filed: Jan. 30, 2015

(30) Foreign Application Priority Data
Mar. 18, 2014 (JP) 2014-055558

(51) Int. Cl. F16H 3/72

(52) U.S. Cl. CPC F16H 3/725; F16H 3/728

(57) ABSTRACT

According to an embodiment, a torque mixing device includes a planetary gear unit, a first motor, and a controller. The planetary gear unit includes a ring gear to be rotated by a torque externally applied, a sun gear arranged inside the ring gear, a planetary gear arranged between the ring gear and the sun gear and engaging with the ring gear and the sun gear, and a carrier supporting the planetary gear so that the planetary gear is revolvable around the sun gear. The first motor is connected to the carrier, and rotationally drives the carrier. The controller controls the first motor to produce a torque according to a differential signal between a signal obtained by amplifying an angular velocity of the ring gear and an angular velocity of the carrier.

### CROSS-REFERENCE TO RELATED APPLICATIONS

This application is based upon and claims the benefit of priority from Japanese Patent Application No. 2014-055558, filed Mar. 18, 2014, the entire contents of which are incorporated herein by reference.

### FIELD

Embodiments described herein relate generally to a power-assisted apparatus including a torque mixing device.

### BACKGROUND

There exists a power-assisted apparatus which supports the movements of a human user by using a motor. Such a power-assisted apparatus includes a torque mixing device which mixes a torque produced by a user and an assist torque produced by a motor. In conventional torque mixing devices, the assist torque has a low followability to the torque produced by a user. Therefore, conventional torque mixing devices do not provide a natural operational sensation that the power-assisted apparatus is a part of the body of a user.

### BRIEF DESCRIPTION OF THE DRAWINGS

FIG. 1 is a side view showing an exterior of a power-assisted apparatus according to a first embodiment.

FIG. 2 is a cross-sectional view of the power-assisted apparatus taken along line II-II′ shown in FIG. 1.

FIG. 3 is a block diagram showing a control system of the power-assisted apparatus according to the first embodiment.

FIG. 4 shows a relationship between the angular velocity of a ring gear and that of a carrier in the case where torque control according to the first embodiment is performed.

FIG. 5 shows a relationship between a torque exerted on the ring gear and a torque exerted on the carrier in the case where torque control according to the first embodiment is performed.

FIG. 6 is a partial cutaway diagram showing a power-assisted apparatus according to a second embodiment.

### DETAILED DESCRIPTION

In general, according to an embodiment, a torque mixing device includes a planetary gear unit, a first motor, and a controller. The planetary gear unit includes a ring gear rotatable around a first axis, the ring gear being to be rotated by a torque externally applied, a sun gear arranged inside the ring gear, the sun gear being rotatable around a second axis, a planetary gear arranged between the ring gear and the sun gear and engaging with the ring gear and the sun gear, and a carrier supporting the planetary gear so that the planetary gear is rotatable around a third axis and revolvable around the sun gear, the carrier being rotatable around a fourth axis, the first axis, the second axis, the third axis and the fourth axis being parallel to each other, the first axis, the second axis and the fourth axis being coaxial. The first motor is connected to the carrier, and rotationally drives the carrier. The controller is configured to control the first motor to produce a torque according to a differential signal between a signal obtained by amplifying an angular velocity of the ring gear and an angular velocity of the carrier.

Hereinafter, embodiments will be described with reference to the drawings. In the following embodiments, the same elements will be assigned the same reference symbols, and redundant explanations will be omitted as appropriate.

### First Embodiment

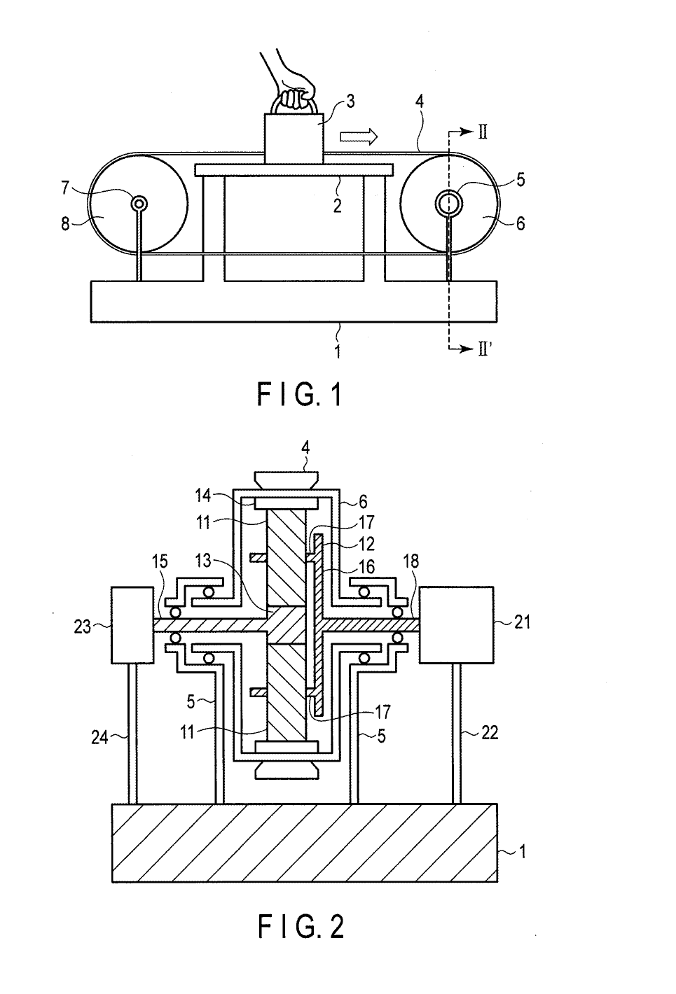

FIG. 1 is a side view schematically showing an exterior of a power-assisted apparatus according to the first embodiment, and FIG. 2 is a cross-sectional view of the power-assisted apparatus taken along line II-II′ shown in FIG. 1. The power-assisted apparatus shown in FIG. 1 includes a base 1. A slide rail 2 is fixed to the base 1. A load 3 is mounted on the slide rail 2. A belt 4 is connected to the load 3, and is wound around a pulley 6 and a pulley 8. The pulley 6 is rotatably supported by a support 5 fixed to the base 1, and the pulley 8 is rotatably supported by a support 7 fixed to the base 1. Each of the pulley 6 and the pulley 8 includes teeth which are formed on its outer periphery. The pulley 6 and the pulley 8 engage with the belt 4. When a user applies a force in a direction along the slide rail 2 (e.g., the direction indicated by the arrow in FIG. 1), the load 3 moves along the slide rail 2, and the pulley 6 and the pulley 8 are rotated by a force transmitted via the belt 4.

As shown in FIG. 2, teeth are also formed on an inner periphery of the pulley 6. The teeth formed on the inner periphery of the pulley 6 correspond to a ring gear 14 of a planetary gear unit 10. A sun gear 13 is arranged inside the ring gear 14. The sun gear 13 includes teeth which are formed on its outer periphery. The sun gear 13 is rotatably supported by the support 5, and connected to a motor 23 attached to a support leg 24 fixed to the base 1. More specifically, the support 5 rotatably supports a central shaft 15 of the sun gear 13, and the motor 23 is coupled with the central shaft 15 of the sun gear 13. The sun gear 13 can rotate with the central shaft 15. A torque produced by the motor 23 is applied to the sun gear 13.

A plurality of planetary gears 11 are arranged between the ring gear 14 and the sun gear 13. Each of the planetary gears 11 includes teeth which are formed on its outer periphery, and engages with the ring gear 14 and the sun gear 13. The planetary gears 11 are supported by a carrier 12 in such a manner that the planetary gears 11 can revolve around the sun gear 13. The carrier 12 is rotatably supported by the support 5, and connected to a motor 21 attached to a support leg 22 fixed to the base 1. For example, the carrier 12 includes a disk 16, a plurality of support shafts 17 extending from a main surface of the disk 16 in a direction perpendicular to the disk 16, and a central shaft 18 extending from another main surface of the disk 16 in the direction perpendicular to the disk 16. The support shafts 17 are attached to the planetary gears 11 so as to pass through the centers of the planetary gears 11, respectively, and the central shaft 18 is coupled with the motor 21. The carrier 12 can rotate around the central shaft 18. Each of the planetary gears 11 can rotate around a corresponding support shaft 17, and can revolve around the sun gear 13. A torque produced by the motor 21 is applied to the carrier 12. In FIG. 1, the motor 21 and the support leg 22 are omitted.

In the planetary gear unit 10, the rotational axes of the carrier 12, the sun gear 13, the ring gear 14, and the planetary gears 11 are parallel to each other, and those of the carrier 12, the sun gear 13, and the ring gear 14 are coaxial. The rotational axis of the sun gear 13 corresponds to the central shaft 15. The rotational axis of the carrier 12 corresponds to the central shaft 18. The rotational axes of the planetary gears 11 correspond to the support shafts 17, respectively.

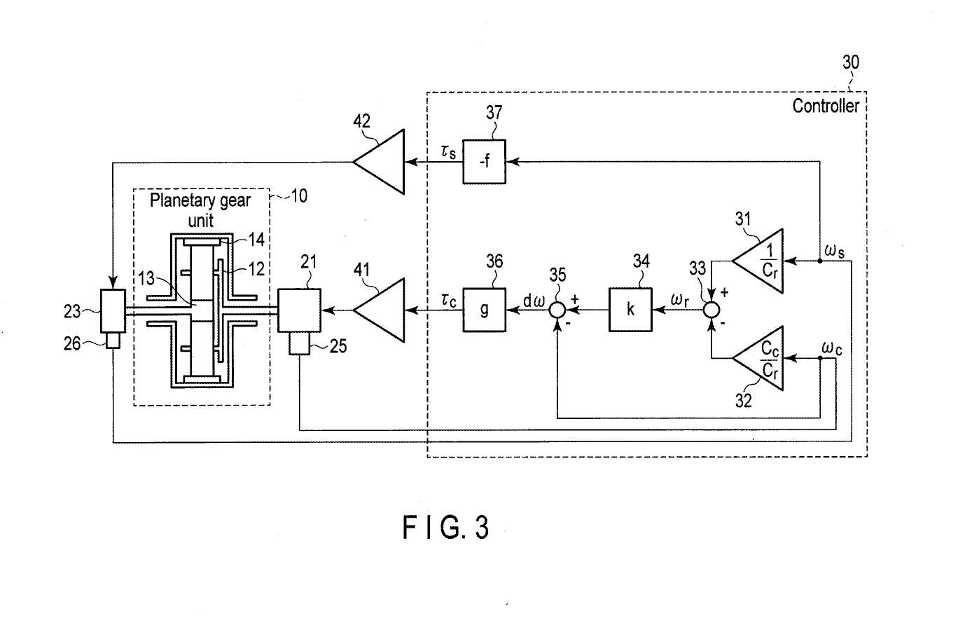

FIG. 3 schematically shows a control system of the power-assisted apparatus according to the present embodiment. As shown in FIG. 3, the motor 21 is provided with an angular velocity detector 25 which detects a rotational angular velocity ω_{c} of the carrier 12, and the motor 23 is provided with an angular velocity detector 26 which detects a rotational angular velocity ωₛ of the sun gear 13. As the angular velocity detector, for example, a rotary encoder or a tacho-generator may be used. When a user applies a force to the load 3 in FIG. 1, the force is transmitted to the pulley 6 via the belt 4, thereby rotating the pulley 6. Namely, a torque is applied to the ring gear 14 of the pulley 6 by the user. As the ring gear 14 rotates, the carrier 12 and the sun gear 13 rotate. At this time, the angular velocity detector 25 detects an angular velocity ω_{c} of the carrier 12, and the angular velocity detector 26 detects an angular velocity ωₛ of the sun gear 13. The angular velocity ω_{c} of the carrier 12 and the angular velocity ωₛ of the sun gear 13 are given to a controller 30. The controller 30 may be implemented in, for example, a microprocessor unit.

The controller 30 performs torque control of the motor 21, which rotationally drives the carrier 12, and the motor 23, which rotationally drives the sun gear 13.

First, the torque control of the motor 21 will be described. The controller 30 calculates an angular velocity ωᵣ of the ring gear 14 based on the angular velocity ω_{c} of the carrier 12 and the angular velocity ωₛ of the sun gear 13. More specifically, the controller 30 calculates an angular velocity ωᵣ of the ring gear 14 based on the following equation (1) for determining the angular velocity ratio of the ring gear 14, the carrier 12, and the sun gear 13 included in the planetary gear unit 10.

$${ω}_{r} = \frac{1}{{c}_{r}} {ω}_{s} - \frac{{c}_{c}}{{c}_{r}} {ω}_{c} \qquad ( 1 )$$

In equation (1), coefficients cᵣ and c_{c} are constants determined based on the ratio between the number of teeth of the ring gear 14 and that of the sun gear 13. For example, when the number of teeth of the ring gear 14 is 120, and that of the sun gear 13 is 12, cᵣ=−10, and c_{c}=11. The processing of equation (1) is executed by a signal amplifier 31 with the gain of 1/cᵣ, a signal amplifier 32 with the gain of c_{c}/cᵣ, and an adder-subtractor 33. The signal amplifier 31 amplifies the angular velocity ωₛ of the sun gear 13. The signal amplifier 32 amplifies the angular velocity ω_{c} of the carrier 12. The adder-subtractor 33 subtracts an output signal of the signal amplifier 32 from an output signal of the signal amplifier 31.

As expressed by the following equation (2), the controller 30 calculates a differential signal dω between a signal obtained by amplifying the angular velocity ωᵣ of the ring gear 14 and the angular velocity ω_{c} of the carrier 12.

dω=kωᵣ−ω_{c} (2)

In equation (2), k may be a constant or expressed by a transfer function. The processing of equation (2) is executed by a signal amplifier 34 with the gain of k, and an adder-subtractor 35. The signal amplifier 34 amplifies the angular velocity ωᵣ of the ring gear 14. The adder-subtractor 35 subtracts the angular velocity ω_{c} of the carrier 12 from an output signal of the signal amplifier 34.

Then, the controller 30 amplifies the differential signal dω to generate an amplified differential signal gdω, as expressed by the following equation (3), and provides the motor 21 with the amplified differential signal gdω as a torque command value τ_{c}. The torque command value τ_{c} is amplified by a signal amplifier 41, and is provided to the motor 21 as a current.

τ_{c}=gdω (3)

In equation (3), g may be a constant or may be expressed by a transfer function. The processing of equation (3) is executed by a signal amplifier 36 with the gain of g.

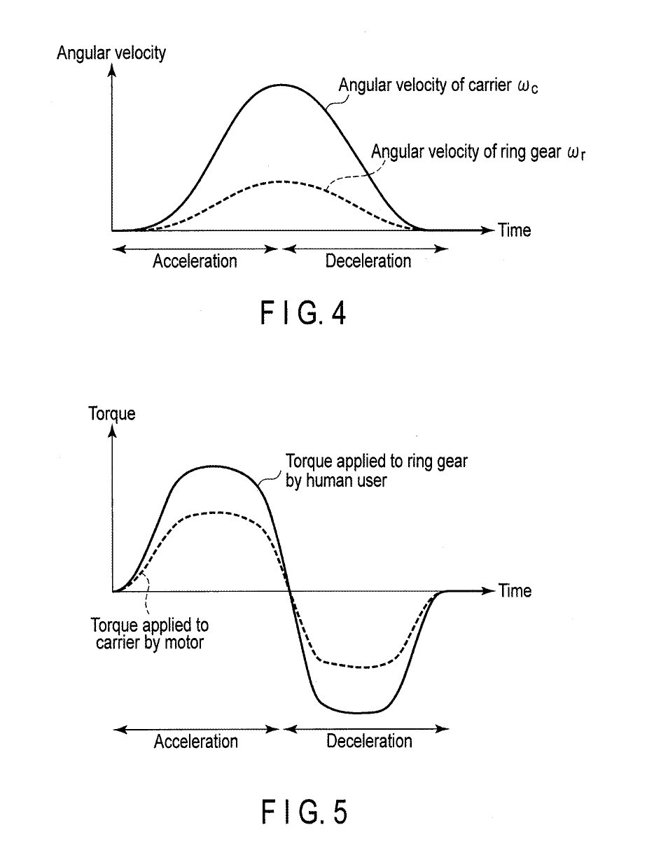

In this manner, the controller 30 controls the motor 21 to produce a torque according to a differential signal, which is obtained by subtracting the angular velocity ω_{c} of the carrier 12 from a signal kωᵣ obtained by amplifying the angular velocity ωᵣ of the ring gear 14 rotated by a torque applied by a user. Namely, the controller 30 causes the motor 21 to produce a torque so that the angular velocity ω_{c} of the carrier 12 follows the signal kωᵣ obtained by amplifying the angular velocity ωᵣ of the ring gear 14. Under the torque control of the controller 30, the motor 21 produces a torque to make a differential signal between the signal kωᵣ obtained by amplifying the angular velocity ωᵣ of the ring gear 14 and the angular velocity ω_{c} of the carrier 12 small (zero). As a result, as shown in FIG. 4, the angular velocity ω_{c} of the carrier 12 has a substantially-proportional relationship with the angular velocity ωᵣ of the ring gear 14 in a temporal axis waveform. Namely, the angular velocity ω_{c} of the carrier 12 changes together with the angular velocity ωᵣ of the ring gear 14. In consideration of the fact that the ring gear 14 and the carrier 12 are both an inertial body, the torques applied thereto, i.e., the assist torque applied to the carrier 12 by the motor 21 and the torque applied to the ring gear 14 by a user also have a substantially-proportional relationship in a temporal axis waveform, as shown in FIG. 5. Namely, the assist torque has a high followablity to the torque produced by a user.

The torque applied to the carrier 12 by the motor 21 is distributed to the ring gear 14 and the sun gear 13 by a torque distribution function, which is a property of the planetary gear unit 10. The torque of the motor 21 distributed to the ring gear 14 is mixed with the torque applied to the ring gear 14 by a user, and used for movement of the load 3. If the torque control of the motor 21 is viewed from a user, the assist torque having a substantially-proportional relationship in a temporal axis waveform with the torque applied to the ring gear 14 by the user is provided from the motor 21, thus the user can feel as if he/she is assisted with a natural sensation in accordance with his/her intention.

Next, the torque control method of the motor 23 will be described. Based on, for example, the following equation (4), the controller 30 amplifies the angular velocity ωₛ of the sun gear 13 to generate an amplified signal −fωₛ, and provides the motor 23 with the amplified signal −fωₛ as a torque command value τₛ. The torque command value τₛ is amplified by a signal amplifier, 42, and is provided to the motor 23 as a current.

τₛ=−fωₛ (4)

In equation (4), f may be a constant or expressed by a transfer function. The processing of equation (4) is executed by a signal amplifier 37 with the gain of −f.

Accordingly, the controller 30 controls the motor 23 to produce a torque in a direction opposite to the rotational direction of the sun gear 13. Namely, the controller 30 causes the motor 23 to produce a torque so that the torque produced by the motor 23 acts as a reaction force of the torque from the motor 21 distributed to the sun gear 13. To indicate that the torque acts as a reaction force, the gain of signal amplifier 37 is expressed by −f. By the torque produced by the motor 23, the torque produced by the motor 21 is efficiently transmitted to the ring gear 14. Furthermore, the motor 23 is controlled to produce a torque according to the angular velocity ωₛ of the sun gear 13, whereby a user can smoothly start moving the load 3 without exerting a large force on the load 3.

A portion including the planetary gear unit 10, the motors 21 and 23, the angular velocity detectors 25 and 26, the controller 30, and the signal amplifiers 41 and 42 corresponds to the torque mixing device.

Described above is a case where the angular velocities of the carrier 12 and the sun gear 13 are detected by using the two angular velocity detectors 25 and 26, respectively, and the angular velocity of the ring gear 14 is calculated based on the detected angular velocities; however, the present embodiment is not limited to this case. Since the angular velocities of the carrier 12, the sun gear 13, and the ring gear 14 satisfy equation (1), above, if two of the angular velocities of the carrier 12, the sun gear 13, and the ring gear 14 are detected, the remaining one angular velocity is automatically determined. Therefore, two angular velocity detectors need to be provided to detect the angular velocities of any two of the carrier 12, the sun gear 13, and the ring gear 14.

As described above, according to the first embodiment, the followablity of the assist torque to the torque exerted by a user can be improved by contorting the motor to produce a torque according to the differential signal between the signal obtained by amplifying the angular velocity of the ring gear and the angular velocity of the carrier. As a result, a natural operational sensation can be realized.

### Second Embodiment

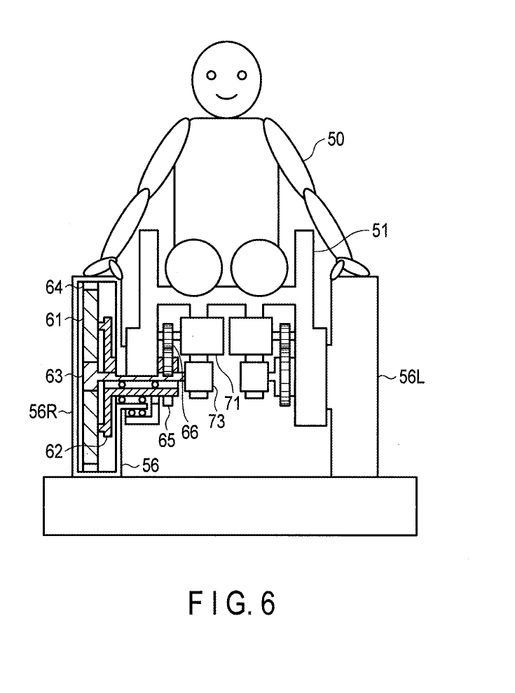

FIG. 6 schematically shows a wheelchair corresponding to a power-assisted apparatus according to the second embodiment. The wheelchair shown in FIG. 6 includes a pair of wheels 56L and 56R rotatably supported by a wheelchair body 51. Each of the wheels 56L and 56R is provided with a mechanism similar to the torque mixing device described in the first embodiment. In FIG. 6, the wheelchair is shown with a portion on the right hand side of the user 50 cut to show the inner structure.

The structure of wheel 56R on the right hand side of the user 50 will be briefly described. The description of the structure of wheel 56L will be omitted as the structure is the same as that of wheel 56R.

A ring gear 64 is fixed to an inner periphery of wheel 56R. The ring gear 64 engages with planetary gears 61.

The planetary gears 61 engage with a sun gear 63, and are supported by a carrier 62 in such a manner that the planetary gears 61 can revolve around the sun gear 63. The sun gear 63 is connected to a motor 73 fixed to the wheelchair body 51. The carrier 62 is connected via gears 65 and 66 to a motor 71 fixed to the wheelchair body 51. In the motors 71 and 73, torque control as described in the first embodiment is performed by a controller (not shown). The motor 71 corresponds to the motor 21 in the first embodiment, and the motor 73 corresponds to the motor 23 in the first embodiment.

In the present embodiment, the user 50 who sits on the wheelchair body 51 exerts a torque on wheels 56L and 56R by hand to move the wheelchair forward or backward. As the wheels 56L and 56R are rotated by the torque applied by the user 50, an assist torque is provided to the user 50 from motor 71.

The second embodiment can produce the same effect as the first embodiment.

While certain embodiments have been described, these embodiments have been presented by way of example only, and are not intended to limit the scope of the inventions.

Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A torque mixing device, comprising:
a planetary gear unit including a ring gear rotatable around a first axis, the ring gear being to be rotated by a torque externally applied, a sun gear arranged inside the ring gear, the sun gear being rotatable around a second axis, a planetary gear arranged between the ring gear and the sun gear and engaging with the ring gear and the sun gear, and a carrier supporting the planetary gear so that the planetary gear is rotatable around a third axis and revolvable around the sun gear, the carrier being rotatable around a fourth axis, the first axis, the second axis, the third axis and the fourth axis being parallel to each other, the first axis, the second axis and the fourth axis being coaxial;
a first motor, connected to the carrier, rotationally driving the carrier; and
a controller configured to control the first motor to produce a torque according to a differential signal between a signal obtained by amplifying an angular velocity of the ring gear and an angular velocity of the carrier.

2. The device according to claim 1, further comprising a second motor, connected to the sun gear, rotationally driving the sun gear, wherein the controller is further configured to control the second motor to produce a torque in a direction opposite to a rotational direction of the sun gear.

3. The device according to claim 1, further comprising two angular velocity detectors to detect angular velocities of two of the sun gear, the ring gear, and the carrier.

4. A method for driving a torque mixing device comprising a planetary gear unit including a ring gear rotatable around a first axis, the ring gear being to be rotated by a torque externally applied, a sun gear arranged inside the ring gear, the sun gear being rotatable around a second axis, a planetary gear arranged between the ring gear and the sun gear and engaging with the ring gear and the sun gear, and a carrier supporting the planetary gear so that the planetary gear is rotatable around a third axis and revolvable around the sun gear, the carrier being rotatable around a fourth axis, the first axis, the second axis, the third axis, and the fourth axis being parallel to each other, the first axis, the second axis, and the fourth axis being coaxial, and a first motor, connected to the carrier, rotationally driving the carrier, the method comprising:
controlling the motor to produce a torque according to a differential signal between a signal obtained by amplifying an angular velocity of the ring gear and an angular velocity of the carrier.
